(19) United States
(12) Patent Application Publication
(10) Pub. No.: US 2026/0334750 A1
(43) Pub. Date: Oct. 29, 2026

(54) CLEANING MITT TREATED WITH CLEANING SOLUTION

(71) Applicant: Athlete Armor LLC, Saco, ME (US)

(72) Inventor: Allen Berube, Saco, ME (US)

(73) Assignee: Athlete Armor LLC, Saco, ME (US)

(21) Appl. No.: 19/229,048

(22) Filed: Jun. 5, 2025

Related U.S. Application Data
(63) Continuation-in-part of application No. 30/000,762, filed on Apr. 24, 2025, now Pat. No. D1135287.

(51) Int. Cl. A47L 13/19; C11D 17/04

(52) U.S. Cl. CPC A47L 13/19; C11D 17/049

(57) ABSTRACT

A cleaning apparatus in the form of a mitt arranged to enable a user to insert a hand within a cavity established between an inner layer and an outer layer of the mitt. At least the inner layer of the mitt is infused with a cleaning solution. The mitt with infused cleaning solution enables a user to clean or treat a surface without separate steps of first applying the cleaning solution to the surface and then using the mitt to clean the surface. The cleaning apparatus can also be used to treat a surface rather than clean a surface.

### BACKGROUND OF THE INVENTION

### 1. Field of the Invention

The present invention relates to a mitt used to wipe surfaces clean. More particularly, the present invention relates to a mitt treated with a cleaning solution. The mitt with embedded or infused cleaning solution eliminates the need to apply a cleaning solution to a surface and then wipe it with the mitt.

### 2. Description of the Prior Art

Cleaning mitts are used to clean a wide range of surfaces. For example, mitts are used to wipe exercise equipment between uses. In this example, a dry mitt is placed on the hand and then the surface is wiped. A cleaning solution may or may not first be applied to the surface before using the mitt. When no cleaning solution is first applied, which is likely more common the situation, the mitt may dry the surface but that is not enough to remove contaminants on the surface.

On the other hand, cleaning wipes treated with cleaning solutions are commonly available. Unfortunately, cleaning wipes can be difficult to use relative to cleaning mitts. The wipes bunch and/or tear while being moved on a surface, particularly when the surface is rough. A mitt is preferred for cleaning rough surfaces due to its integrity and design as a single item that encloses the hand. This limitation is seen in many applications of existing cleaning wipes. In one example, the cleaning of equipment and patients in hospitals is less than optimal with existing cleaning wipes.

What is needed is a better means for effectively cleaning a surface. What is needed for that purpose is a cleaning apparatus that is easy to use with minimal bunching or tearing when in contact with the surface to be cleaned. The apparatus should be combined with a cleaning solution in an integrated way so that it is unnecessary to spray the cleaning solution separate from using the cleaning apparatus. A variety of cleaning solutions should be used to enhance the functionality of the cleaning apparatus so that a variety of surface types can be cleaned. Further, the cleaning apparatus with integrated solution should be suitable for more than just cleaning, such as for use in treating surfaces with desired treatment material. For example, the cleaning apparatus should also be usable to treat surfaces such as automobiles and automobile tires but not limited thereto.

### SUMMARY OF THE INVENTION

It is an object of the present invention to provide a cleaning apparatus that is easy to use with minimal bunching or tearing when in contact with the surface to be cleaned. It is also an object of the invention to provide the cleaning apparatus in combination with a cleaning solution in an integrated way. Further, it is an object of the invention to provide the cleaning apparatus with the integrated cleaning solution for a plurality of purposes.

These objects of the present invention are achieved by integrating a cleaning solution into the cleaning apparatus, which is a mitt. The mitt has an upper region and a lower region. The mitt includes an inner layer joined to an outer layer at outer perimeters thereof to establish an opening therebetween at the lower region of the mitt. The opening is sized to enable a mitt user to insert his or her hand through the opening into a cavity formed between the inner layer and the outer layer. The mitt may be made of one or more materials. For example, an interior surface of either or both of the inner layer and the outer layer may be made of a first material while the exterior surfaces of those layers may be made of a different material. At least the exterior surface of the inner layer is made of a material of sufficient structural integrity to enable multiple cleaning movements on one or more surfaces with limited or no bunching or tearing. The mitt may be made of a cleaning fabric with a smooth or textured surface on at least the inner layer. The mitt may be shaped like a mitten with a thumb portion but not limited thereto. At least the material of the inner layer of the mitt is infused with the cleaning solution.

The amount and type of cleaning solution infused into the material of the mitt is selectable dependent on the desired function of the novel mitt of the present invention. The infusion of the cleaning solution into the mitt material may be performed in the manner that cleaning solutions are infused into cleaning wipes. Examples of cleaning solutions infused into the mitt include, but are not limited to the following alone or in any combination thereof:
Benzalkonium chloride
C12-14 alkyl dimethyl ethylbenzyl ammonium chloride
Alkyl polyglucoside
Propylene glycol
Phenoxyethanol
Propylene glycol
Dimenthyl ethylbenzyl chloride
Dimenthyl benzoyl ammonium chloride
Ammonium chloride
Benzalkonium Chloride
Isopropyl Alcohol
Ethanol
Chlorhexidine gluconate
Hydrogen Peroxide
benzalkonium chloride
didecyldimonium chloride
Polydimethylsiloxane
Dipropylene Glycol Butyl Ether
Propylene Glycol
Mineral oil
DEET
Abobenzone
Homosalate
Octisalate
Octocrylene
Aloe
Camellia Sinensis Leaf Extract
Cucumis Sativus (Cucumber Fruit Extract)
Chamomilla Recutita Flower Extract
Aloe Barbadensis Leaf Extract
Tocopheryl Acetate
Vitamin E
Caprylyl/Capryl Glucoside
Potassium Cocoate
Levulinic Acid
Sodium Benzoate

The cleaning mitt of the present invention infused with cleaning solution may be used to clean athletic equipment, automotive components, household surfaces, and any other surface of interest but not limited thereto. In one example, the cleaning mitt is useful in the healthcare world as it can be quickly and effectively deployed to clean patients and to clean equipment. The cleaning mitt may also be infused with a solution that is not chosen to clean a surface but rather to treat a surface. For example, the mitt may be used to apply oil to a wood surface, a coating to a tire surface, or any other treatment function of interest. The use of a mitt rather than a simple sheet of material ensures effective surface cleaning or treatment with limited bunching or tearing of the mitt material. A mitt is generally easier to use than a simple sheet and yet, until the present invention, cleaning mitts have always been separate from the cleaning solution. The present invention eliminates the extra step and reduced impact of applying the cleaning solution and then separately wiping the applied solution. The mitt may sometimes used to wipe a surface without any cleaning solution, rendering that wiping less effective. The present invention eliminates those limitations by combining the cleaning solution and the mitt.

This advantage of the present invention will become further apparent upon review of the following detailed description, accompanying drawings, and appended claims.

### BRIEF DESCRIPTION OF THE DRAWINGS

FIG. 1 is a first perspective view of the cleaning mitt of the present invention.

FIG. 2 is a second perspective view of the cleaning mitt.

FIG. 3 is a front elevation view of the cleaning mitt.

FIG. 4 is a back elevation view of the cleaning mitt.

FIG. 5 is a right-side elevation view of the cleaning mitt.

FIG. 6 is a left-side elevation view of the cleaning mitt.

FIG. 7 is a top plan view of the cleaning mitt.

FIG. 8 is a bottom plan view of the cleaning mitt.

FIG. 9 is third perspective view of the cleaning mitt of the present invention.

### DETAILED DESCRIPTION OF THE INVENTION

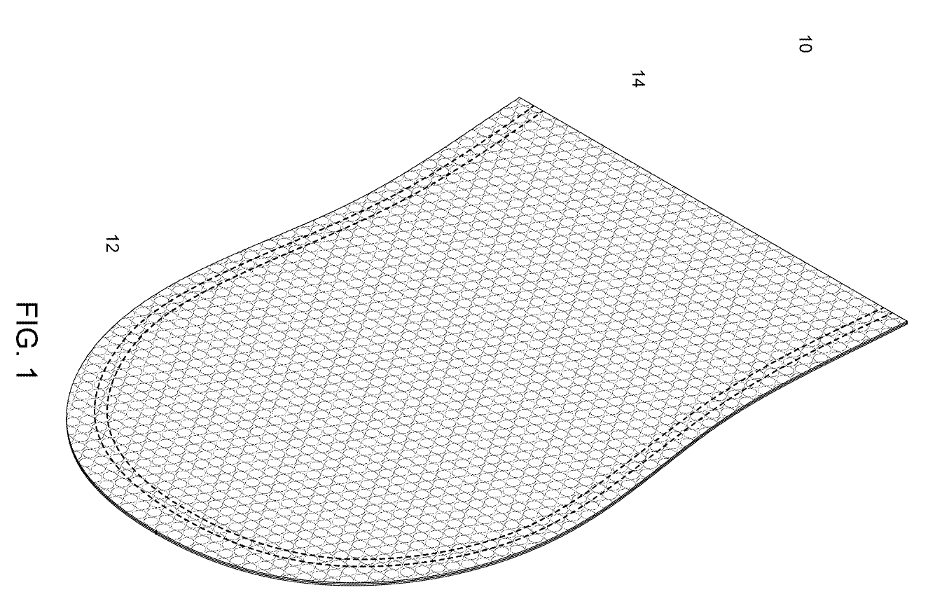

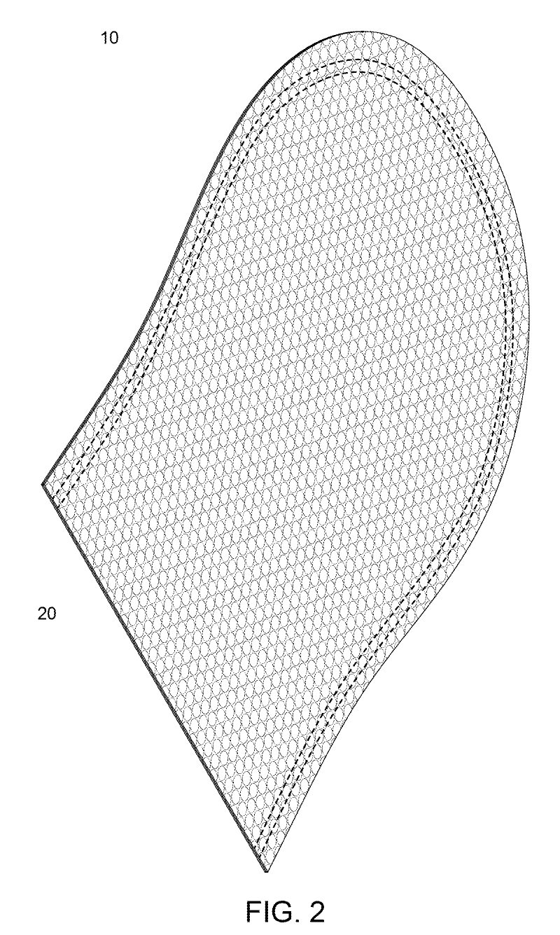

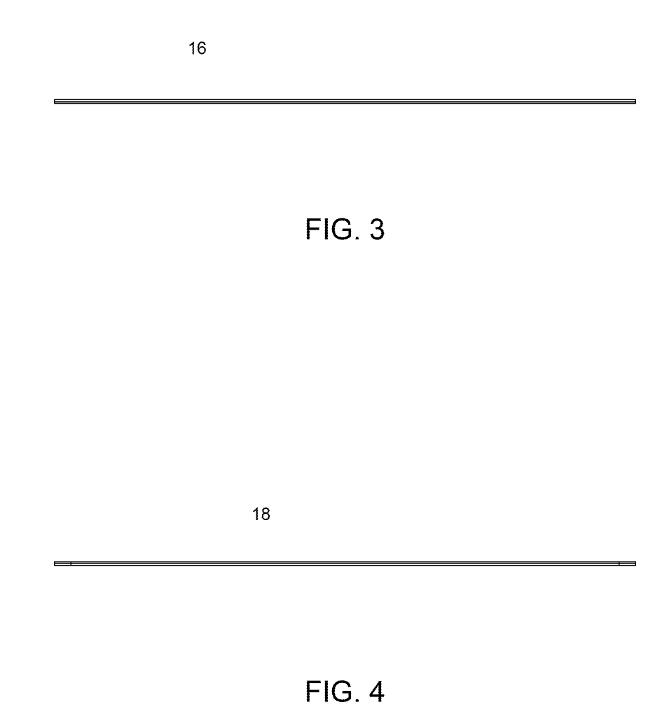

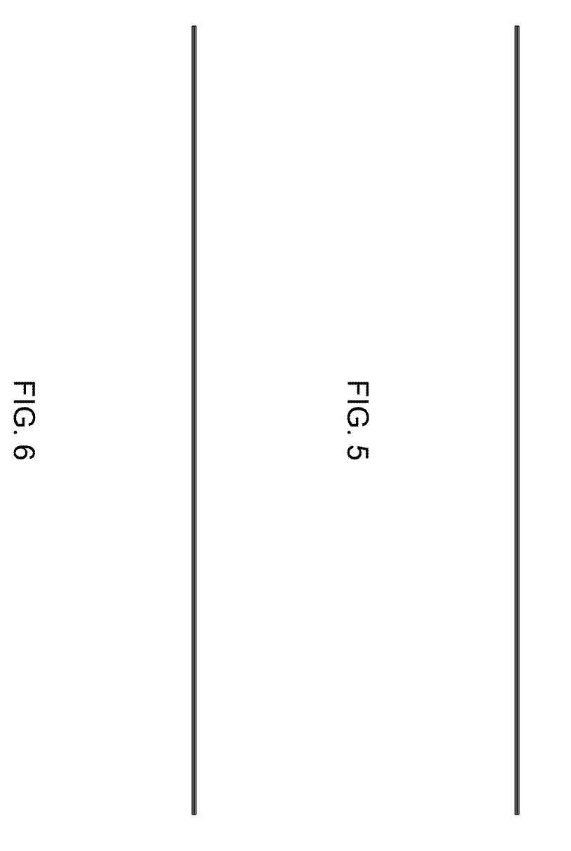

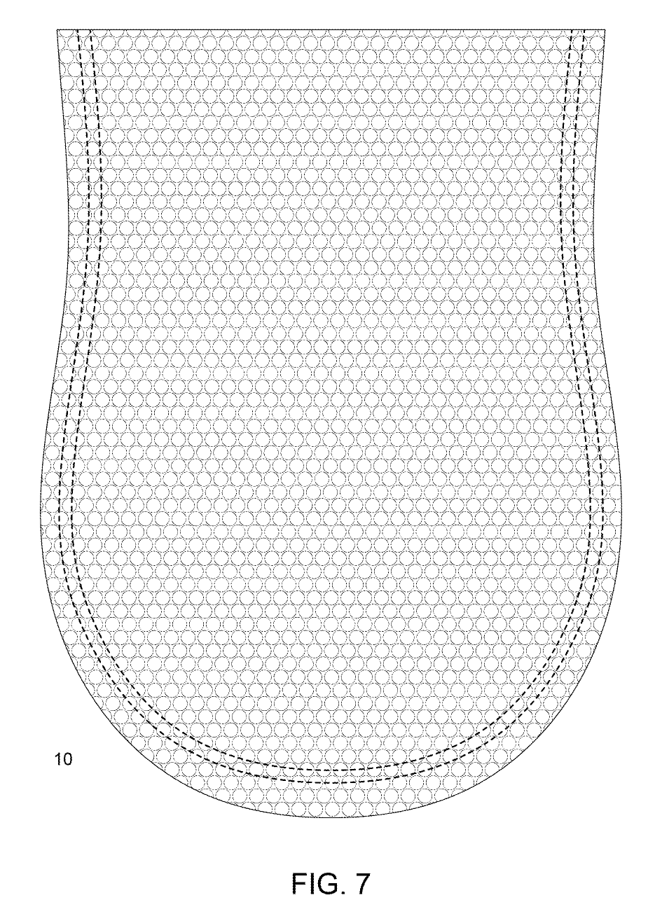

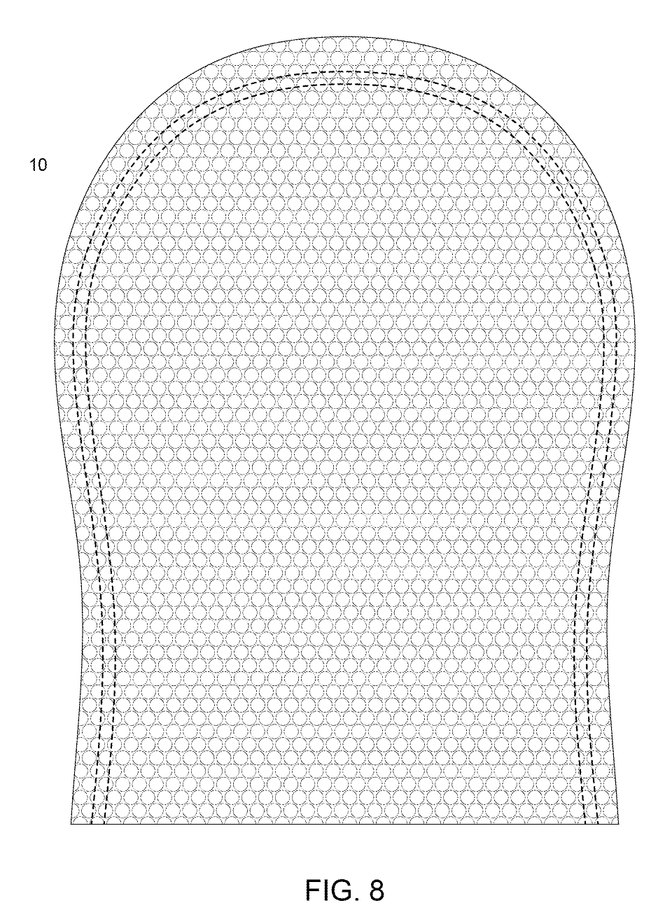

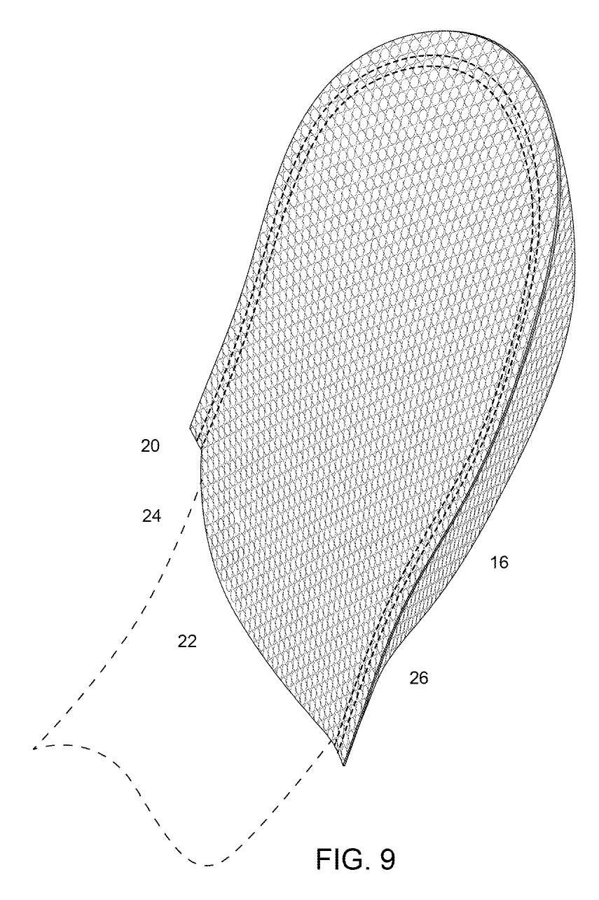

A cleaning apparatus 10 of the present invention is shown in FIGS. 1-9. The apparatus 10 is a mitt 10 with an upper region 12 and a lower region 14. The mitt 10 includes an inner layer 16 joined to an outer layer 18 at outer perimeters thereof such as with stitching but not limited thereto. The inner layer 16 and the outer layer 18 together establish an opening 20 therebetween at the lower region 14 of the mitt 10. The opening 20 is sized to enable a mitt user to insert his or her hand 22 through the opening 20 into a cavity 24 formed between the inner layer 16 and the outer layer 18 at the lower region 14. The mitt 10 may be made of one or more materials. For example, an interior surface of either or both of the inner layer 16 and the outer layer 18 may be made of a first material while exterior surfaces 26 of those layers 16/18 may be made of a different material. At least the exterior surface 26 of the inner layer 16 is made of a material of sufficient structural integrity to enable multiple cleaning movements on one or more surfaces with limited or no bunching or tearing. The mitt 10 may be made of a cleaning fabric with a smooth or textured surface on at least the exterior surface 26 of the inner layer 16. The mitt 10 may be shaped like a mitten with a thumb portion but not limited thereto. At least the material of the inner layer 16 of the mitt is infused with a cleaning solution.

The amount and type of cleaning solution infused into the material of the mitt 10 is selectable dependent on the desired function of the novel mitt of the present invention. The infusion of the cleaning solution into the mitt material may be performed in the manner that cleaning solutions are infused into cleaning wipes. An example of a service provider with the capability to infuse the cleaning solution into the mitt 10 is Riway International of China. Examples of cleaning solutions infused into the mitt 10 include, but are not limited to the following alone or in any combination thereof:
Benzalkonium chloride
C12-14 alkyl dimethyl ethylbenzyl ammonium chloride
Alkyl polyglucoside
Propylene glycol
Phenoxyethanol
Propylene glycol
Dimenthyl ethylbenzyl chloride
Dimenthyl benzoyl ammonium chloride
Ammonium chloride
Benzalkonium Chloride
Isopropyl Alcohol
Ethanol
Chlorhexidine gluconate
Hydrogen Peroxide
benzalkonium chloride
didecyldimonium chloride
Polydimethylsiloxane
Dipropylene Glycol Butyl Ether
Propylene Glycol
Mineral oil
DEET
Abobenzone
Homosalate
Octisalate
Octocrylene
Aloe
Camellia Sinensis Leaf Extract
Cucumis Sativus (Cucumber Fruit Extract)
Chamomilla Recutita Flower Extract
Aloe Barbadensis Leaf Extract
Tocopheryl Acetate
Vitamin E
Caprylyl/Capryl Glucoside
Potassium Cocoate
Levulinic Acid
Sodium Benzoate.

The present invention has been described with reference to specific examples and configurations. The description is not to be taken in a limiting sense but is made merely for the purpose of illustrating the general principles of the invention, since the scope of the invention is best defined by the appended claims.

What is claimed is:

1. A cleaning apparatus comprising:
a mitt having an inner layer and an outer layer joined together on perimeters thereof except with an opening between the two layers at an opening location, wherein the opening is configured to allow a user to insert a hand between the inner layer and the outer layer; and
a cleaning solution infused into the inner layer of the mitt.

2. The cleaning apparatus of claim 1, wherein the cleaning solution is also infused into the outer layer of the mitt.

3. The cleaning apparatus of claim 1, wherein the cleaning solution is selected from the group consisting of:
Benzalkonium chloride
C12-14 alkyl dimethyl ethylbenzyl ammonium chloride
Alkyl polyglucoside
Propylene glycol
Phenoxyethanol
Propylene glycol
Dimenthyl ethylbenzyl chloride
Dimenthyl benzoyl ammonium chloride
Ammonium chloride
Benzalkonium Chloride
Isopropyl Alcohol
Ethanol
Chlorhexidine gluconate
Hydrogen Peroxide
benzalkonium chloride
didecyldimonium chloride
Polydimethylsiloxane
Dipropylene Glycol Butyl Ether
Propylene Glycol
Mineral oil
DEET
Abobenzone
Homosalate
Octisalate
Octocrylene
Aloe
Camellia Sinensis Leaf Extract
Cucumis Sativus (Cucumber Fruit Extract)
Chamomilla Recutita Flower Extract
Aloe Barbadensis Leaf Extract
Tocopheryl Acetate
Vitamin E
Caprylyl/Capryl Glucoside
Potassium Cocoate
Levulinic Acid and
Sodium Benzoate.

4. The cleaning apparatus of claim 1, wherein the cleaning apparatus is used to clean a surface.

5. The cleaning apparatus of claim 1, wherein the cleaning apparatus is used to treat a surface.
